(19) United States
(12) Patent Application Publication
(10) Pub. No.: US 2015/0161606 A1
(43) Pub. Date: Jun. 11, 2015

(54) METHOD AND SYSTEM FOR ASSESSING FINANCIAL CONDITION OF A MERCHANT

(71) Applicant: MASTERCARD INTERNATIONAL INCORPORATED, Purchase, NY (US)

(72) Inventor: Edward Lee, Scarsdale, NY (US)

(73) Assignee: MASTERCARD INTERNATIONAL INCORPORATED, Purchase, NY (US)

(21) Appl. No.: 14/103,113

(22) Filed: Dec. 11, 2013

(51) Int. Cl. G06Q 20/40; G06Q 50/00

(52) U.S. Cl. CPC G06Q 20/405; G06Q 50/01

(57) ABSTRACT

A method and a system are provided for assessing the financial condition of a merchant. The method involves retrieving from one or more databases, a first set of information including merchant aggregated payment card transaction data for a defined time period, and retrieving from one or more databases a second set of information including social media information indicative of consumer sentiment of the merchant for the defined time period. The method further involves analyzing the first set of information and the second set of information to identify one or more correlations between the merchant aggregated payment card transaction data and the social media information indicative of consumer sentiment of the merchant, and assessing the financial condition of a merchant, based on the one or more correlations. A merchant is informed in a timely manner of any changes in their financial condition, thereby allowing the merchant to take remedial action.

### BACKGROUND OF THE DISCLOSURE

1. Field of the Disclosure

The present disclosure relates to a method and a system for assessing the financial condition of a merchant. In particular, one or more correlations are identified between merchant aggregated payment card transaction data and social media information indicative of consumer sentiment of the merchant. Based on the one or more correlations, the financial condition of the merchant is assessed.

2. Description of the Related Art

Entities, such as large companies, want to monitor the public's sentiment, or perception of their company, product, organization, or the like. For example, the general public may comment on a company in a variety of media, including social media sites, microblogs, blogs, video posting sites and a variety of other websites. By way of example, a company will likely benefit from knowing the public's current sentiment regarding a product, for example, (the current “buzz”) as to whether the product is noticed in general following a marketing campaign, whether the product is liked or disliked, and so forth. The company's overall reputation is also important to know.

Websites that allow users to interact with one another have exploded in popularity in the last few years. Social networking websites sites such as FACEBOOK® and LINKEDIN®, and microblogging websites such as TWITTER® enjoy widespread use. Millions of users post messages, images and videos on such websites on a daily, even hourly basis, oftentimes reporting events on a real-time or near-time basis, and revealing the user's activities and interests. Users typically direct messages to specific persons, their social group, or perhaps merchants or businesses maintaining a presence on the social networking websites. Such messages are oftentimes visible to the general public.

Such publicly accessible social media represents a potentially rich mine of information that can provide insight into the public's current sentiment regarding merchants and businesses. Such information may be of great interest to various types of merchants or business organizations. For example, a network provider may wish to track or monitor all messages describing network problems across the country on a real time basis. In another example, a national hotel chain may wish to track or monitor all messages relating to its hotel services, and in particular, messages reporting problems experienced by hotel guests.

Merchant aggregation data includes payment card transaction data associated with a particular merchant. Such merchant aggregation data can provide insight into current customer base affiliation and loyalty regarding the merchant, especially when trended over time. Such information may be of great interest to various types of merchants or business organizations. For example, a merchant may wish to know the number of merchant aggregated payment card transactions, or the gross dollar volume (GDV) of merchant aggregated payment card transactions, on a real time basis or trended over time.

A method and/or a system are needed that leverage up-to-date public sentiment regarding merchants and businesses and merchant aggregated payment card transaction data, in a way that enables merchants to more closely monitor the financial condition of their businesses. There is a need for a system and a method that would ensure merchants are informed in a timely manner of any changes in financial condition of the merchant, thereby allowing the merchants to take remedial action.

### SUMMARY OF THE DISCLOSURE

The present disclosure provides a method and a system for assessing the financial condition of a merchant. In particular, one or more correlations are identified between merchant aggregated payment card transaction data and social media information indicative of consumer sentiment of the merchant. Based on the one or more correlations, the financial condition of a merchant is assessed.

The present disclosure also provides a computer implemented method that involves retrieving from one or more databases, a first set of information including merchant aggregated payment card transaction data for a defined time period, and retrieving from the one or more databases a second set of information comprising social media information indicative of consumer sentiment of the merchant for the defined time period. The method further involves analyzing the first set of information and the second set of information at a processor to identify one or more correlations between the merchant aggregated payment card transaction data and the social media information indicative of consumer sentiment of the merchant, and assessing the financial condition of the merchant based on the one or more correlations.

The present disclosure provides a system that includes one or more databases comprising a first set of information including merchant aggregated payment card transaction data for a defined time period, and one or more databases comprising a second set of information including social media information indicative of consumer sentiment of the merchant for the defined time period. The system further includes a processor configured to analyze the first set of information and the second set of information to identify one or more correlations between the merchant aggregated payment card transaction data and the social media information indicative of consumer sentiment of the merchant, and assess the financial condition of the merchant based on the one or more correlations.

In accordance with the present disclosure, a method and a system are provided that leverage up-to-date public sentiment regarding a merchants and business and merchant aggregated payment card transaction data, in a way that enables the merchant to more closely monitor the financial condition of his/her business. In accordance with the present disclosure, a merchant is informed in a timely manner of any changes in his/her financial condition, thereby allowing the merchant to take remedial action.

### BRIEF DESCRIPTION OF THE DRAWINGS

FIG. 1 is a diagram of a four party payment card system.

FIG. 2 shows illustrative information types used in the systems and methods of the present disclosure.

FIG. 3 illustrates an exemplary dataset for the storing, reviewing, and/or analyzing of information used in the systems and methods of the present disclosure.

FIG. 4 illustrates a high-level view of social media data mining analysis in the context of a network of users and social media sources in accordance with exemplary embodiments of this disclosure.

FIG. 5 illustrates a detailed view of a server used in social media data mining analysis in accordance with exemplary embodiments of this disclosure.

FIG. 6 illustrates a method for social media data mining in accordance with exemplary embodiments of this disclosure.

FIG. 7 shows a block diagram of a data processing system that can be used in social media data mining in accordance with exemplary embodiments of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of this disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, “social media” refers to any type of electronically-stored information that users send or make available to other users for the purpose of interacting with other users in a social context. Such media can include directed messages, status messages, broadcast messages, audio files, image files and video files. Reference in this disclosure to “social media websites” should be understood to refer to any website that facilitates the exchange of social media between users. Examples of such websites include social networking websites such as FACEBOOK and LINKEDIN, and microblogging websites such as TWITTER. Social media also refers to newspapers and magazines.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to leverage up-to-date public sentiment regarding merchants and businesses and merchant aggregated payment card transaction data, in a way that enables merchants to more closely monitor the financial condition of their businesses. Merchants are informed in a timely manner of any changes in their financial condition, thereby allowing the merchants to take remedial action. In accordance with this disclosure, a payment card company will have access both to payment card transaction data associated with a merchant, and to up-to-date public sentiment regarding the merchant, that will enable the payment card company to assess the financial condition of the particular merchant (e.g., whether the merchant is in a distressed condition or a booming condition), and possibly offer services to the merchant aimed at strategies for improving the financial condition of the merchant.

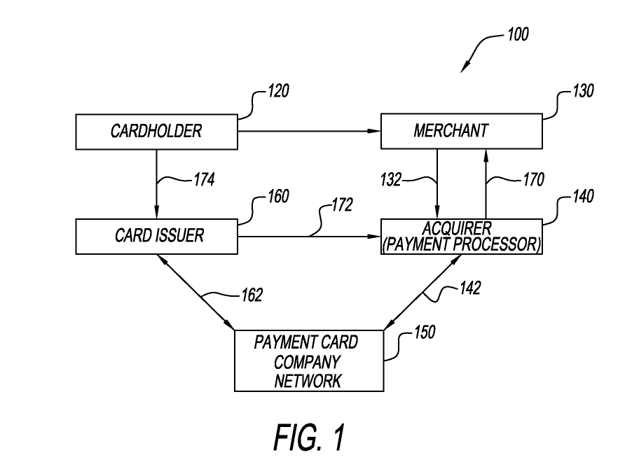

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

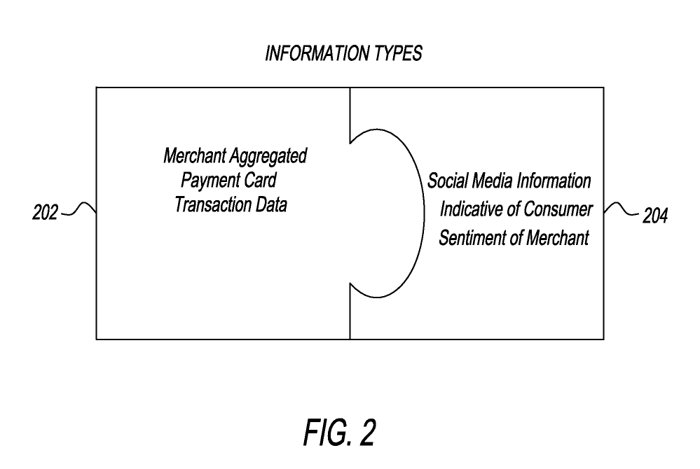

FIG. 2 shows illustrative information types included in data sources used in the systems and methods of this disclosure. Illustrative merchant aggregated payment card transaction data 202 includes, for example, payment card transaction data, merchant data, and optionally geographic and/or demographic information. Illustrative merchant aggregated payment card transaction data 202 also includes, for example, merchant name, merchant address, merchant location(s) of business, hierarchical organizational structure, and the like. Illustrative social media information indicative of consumer sentiment of the merchant 204 includes, for example, information concerning the merchant that is retrieved from TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines.

The transaction payment card data source includes information related to payment card transactions and actual spending. Information for inclusion in the transaction payment card data source can be obtained, for example, from payment card companies known as MasterCard®, Visa®, American Express®, and the like (part of the payment card company network 150 in FIG. 1).

The transaction payment card information can contain, for example, billing activities attributable to the financial transaction processing entity (e.g., a payment card company) and purchasing and payment activities attributable to purchasers (e.g., payment card holders). Illustrative transaction behavior information can include, for example, financial (e.g., billing statements and payments), purchasing information, demographic (e.g., age and gender), geographic (e.g., zip code and state or country of residence), and the like.

In accordance with this disclosure, the merchant aggregated payment card transaction data source can be supplemented or leveraged to enable accurate merchant aggregation data. The accurate merchant aggregation data, together with the social media information indicative of consumer sentiment of the merchant, enables the merchant to accurately monitor the financial condition of its business. Illustrative leveraged data sources can include firmographics (e.g., information related to merchant employees and revenues), risk (e.g., information related to open lines of credit, utilization and risk score for a merchant), and attitudinal (e.g., information related to payment card holder dynamics, satisfaction and concerns with a merchant). These leveraged data sources can supplement information in the merchant aggregated payment card transaction data source.

The firmographics data source includes information related to employees, revenues and industries. In particular, information for inclusion in the firmographics data source relates to information on merchants for use in credit decisions, business-to-business marketing and supply chain management.

Illustrative information in the firmographics data source includes, for example, information concerning merchant background, merchant history, merchant special events, merchant operation, merchant payments, merchant payment trends, merchant financial statement, merchant public filings, and the like merchant information.

Merchant background information can include, for example, ownership, history and principals of the merchant, and the operations and location of the merchant.

Merchant history information can include, for example, incorporation details, par value of shares and ownership information, background information on management, such as educational and career history and company principals, related companies including identification of affiliates including, but not limited to, parent, subsidiaries and/or branches worldwide. The merchant history information can also include corporate registration details to verify the existence of a registered organization, confirm legal information such as a merchant's organizational structure, date and state of incorporation, and research possible fraud by reviewing names of principals and business standing within a state.

Merchant special event information can include, for example, any developments that can impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Merchant operational information can include, for example, the identity of the parent company, the number of accounts and geographic scope of the business, typical selling terms, and whether the merchant owns or leases its facilities. The names and locations of branch operations and subsidiaries can also be identified.

Merchant payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Merchant payment trend information can include, for example, information that spots trends in a merchant's business by analyzing how it pays its bills.

Merchant financial statement information can include, for example, a formal record of the financial activities and a snapshot of a merchant's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss accounts provide information on the operation of the enterprise. These accounts include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Merchant public filing information can include, for example, bankruptcy filings, suits, liens, and judgment information obtained from Federal and State court houses for a company.

The risk data source includes information related to open lines of credit, utilization and risk score. In particular, information for inclusion in the risk data source relates to information concerning credit services, marketing services, decision analytics and consumer services. The risk data source can also include information on people, businesses, motor vehicles and insurance. The risk data source can also include ‘lifestyle’ data from on-line and off-line surveys.

The attitudinal data source includes information related to payment card holder dynamics, satisfaction and concerns. Information for inclusion in the attitudinal data source can be obtained, for example, from payment card companies known as MasterCard®, Visa®, American Express®, and the like (part of the payment card company network 150 in FIG. 1).

Different from the social media data mining information indicative of consumer sentiment of a merchant, the attitudinal information can contain, for example, information from surveys conducted by the financial transaction processing entity (e.g., a payment card company), spending behaviors, payment behaviors, growth opportunities, attitudes in the industry, supply and demand, product trends, and the like.

While accurate and up-to-date merchant aggregated payment card transaction data, together with the social media information indicative of consumer sentiment of the merchant, are of primary concern for enabling a merchant to accurately monitor the financial condition of its business, the additional information described above can also be useful in more fully understanding the merchant and/or contributing to the overall assessment of the financial condition of the merchant.

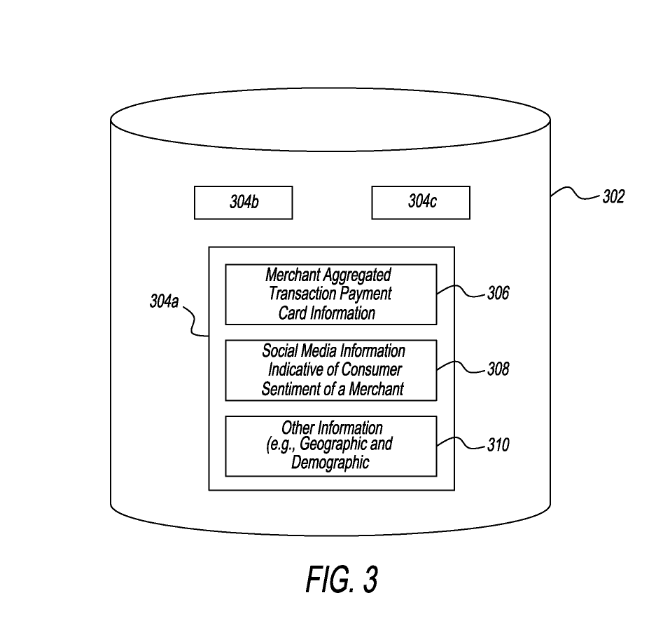

FIG. 3 illustrates an exemplary dataset 302 for the storing, reviewing, and/or analyzing of information used in the systems and methods of this disclosure. The dataset 302 can contain a plurality of entries (e.g., entries 304a, 304b, and 304c).

The merchant aggregated transaction payment card information 306 includes payment card transactions and actual spending. The merchant aggregated transaction payment card information 306 can contain, for example, billing activities attributable to the financial transaction processing entity (e.g., a payment card company) and purchasing and payment activities attributable to purchasers (e.g., payment card holders). The social media information indicative of consumer sentiment of a merchant 308 includes, for example, information concerning the merchant that is retrieved from TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines. Other information 310 can include geographic or demographic or other suitable information that can be useful in conducting the systems and methods of this disclosure.

Algorithms can be employed to determine formulaic descriptions of the integration of the data source information using any of a variety of known mathematical techniques. These formulas, in turn, can be used to derive or generate one or more analyses and updates for a correlation activity using any of a variety of available trend analysis algorithms. For example, these formulas can be used to analyze a first set of information including merchant aggregated payment card transaction data and a second set of information including social media information indicative of consumer sentiment of a merchant to identify one or more correlations between the merchant aggregated payment card transaction data and the social media information indicative of consumer sentiment of a merchant, and assess the financial condition of the merchant based on the one or more correlations.

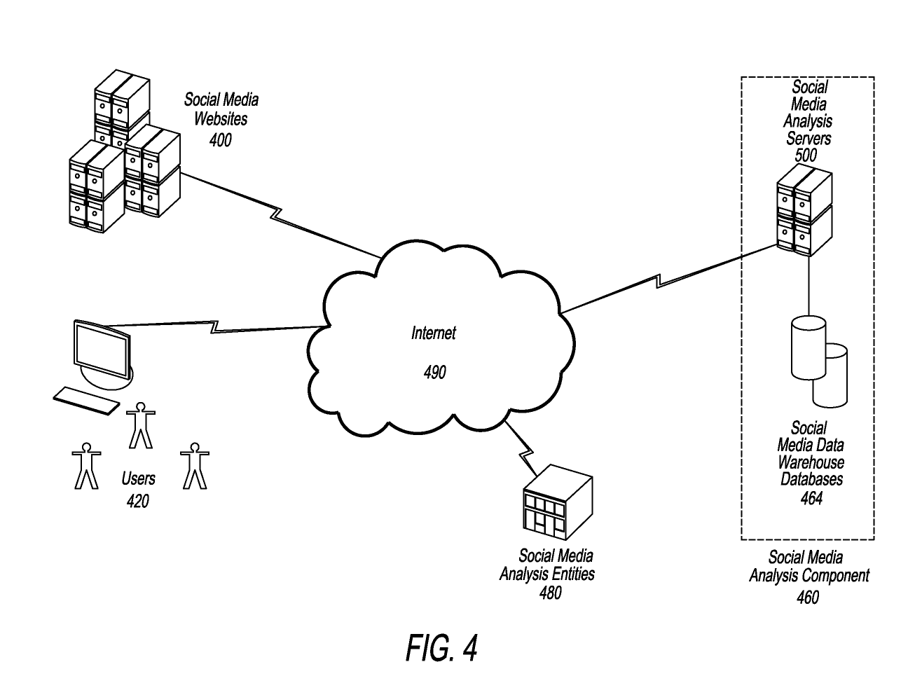

In accordance with this disclosure, one or more databases are provided that comprise a second set of information. The second set of information includes social media information indicative of consumer sentiment of a merchant for a defined time period. The second set of information is retrieved from, for example, TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines. Preferred processes for social media data mining to obtain information regarding consumer sentiment of a merchant are described herein. Illustrative embodiments of such processes for social media data mining to obtain information regarding consumer sentiment of a merchant are shown in FIGS. 4-7.

Various embodiments of the systems and methods disclosed herein collect social media gathered from a plurality of social media websites 400 (FIG. 4) and provide various interfaces and reporting functions to allow end users to track consumer sentiment of a merchant. FIG. 4 illustrates a high-level view of a social media analysis process in the context of a network of users and social media sources. A plurality of users 420 interact with one another via a plurality of social media websites 400 such as, for example, social networking and microblogging websites, via internet 490.

A social media analysis component 460 includes one or more social media analysis servers 500 that collect social media from social media websites 400 and store such social media in one or more social media data warehouse databases 464. The social media analysis servers 500 provide one or more user interfaces that allow social media analysis entities (e.g., a payment card company) 480 to view and analyze aggregated social media stored on the social media data warehouse databases 464. Such entities can include any type of business that has an interest in the content of social media. In one embodiment, the social media analysis component 460 and the social media analysis entities 480 can be within a single organization. In another embodiment, the social media analysis component 460 and the social media analysis entities 480 can be within two separate organizations.

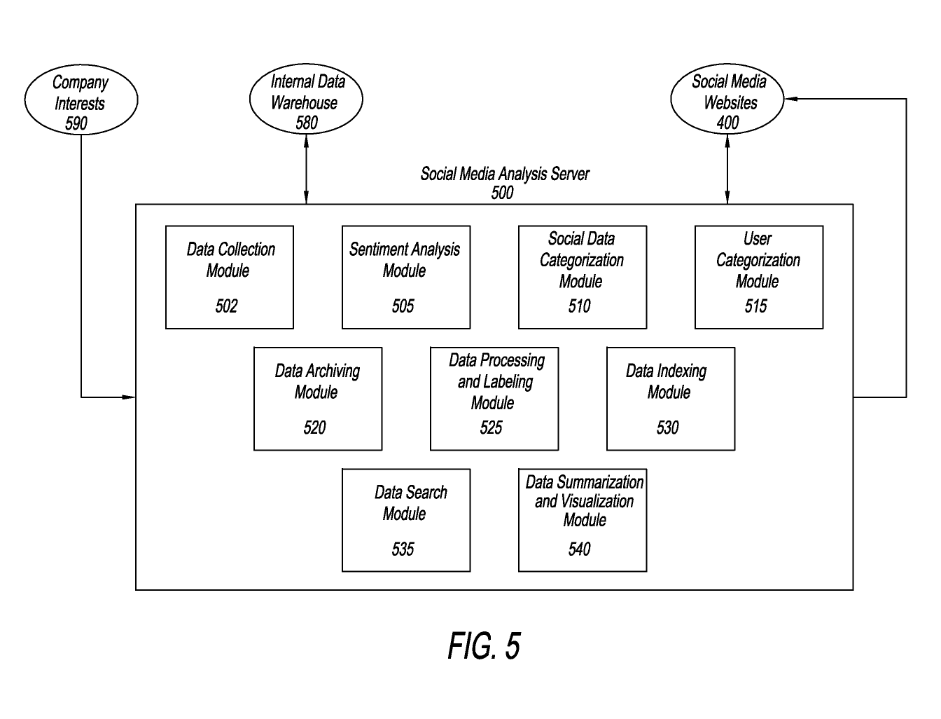

FIG. 5 illustrates a more detailed view of a social media analysis server 500. In the illustrated embodiment, social media analysis server 500 collects social media from various social media websites 400, stores the collected media in an internal data warehouse 580 and provides access to the warehoused social media to one or more entities.

The social media analysis server 500 includes a number of modules that provide various functions related to social media collection analysis. The social media analysis server 500 includes a data collection module 502 that collects social media from social media websites 400. The data collection module 502 collects social media that relates to company interests 590, such as, for example, posts that reference the company by name, posts that relate to specific topics, and/or posts that relate to specific users.

The social media analysis server 500 includes a sentiment analysis module 505 that attempts to determine the nature of the sentiments, such as tone and mood, expressed by users in social media posts. The social media analysis server 500 includes a social data categorization module 510 that categorizes social media postings by, for example, topic, company, mood or tone. The social media analysis server 500 includes user categorization module 515 that categorizes users, for example, by various demographic characteristics or usage patterns. The social media analysis server 500 includes a data archiving module 520 that archives collected social media in the internal data warehouse 580 in association user profiles and user social connections of users relating to the social media. The social media analysis server 500 includes a data processing and labeling module 525 that labels social media data with various tags, such as categories determined by the social data categorization module 510 and the user categorization module 515. The social media analysis server 500 includes a data indexing module 530 that indexes archived social media by one or more properties. Such properties can include, for example, key words, user sentiments, or user demographics. The social media analysis server 500 includes a data search module 540 that provides facilities allowing users to search archived social media using search criteria such as, for example, one or more keywords or key phrases.

The social media analysis server 500 includes a data summarization and visualization module 540 that allows social data analysis entities to query social media archived in the internal data warehouse 580. The data summarization and visualization module 540 uses the aggregated social media, along with associated archived user profile information and user social connections to support high-level consumer sentiment of a merchant intelligence through data mining. The output of data mining and analysis is stored on a database and indexed by the data archiving module along with archived posts, user profiles, and user social connection to support expanded search capabilities. The summarization and visualization module 540 provides various views into the aggregated social media. Such visualized information can be used to better understand consumer sentiment of a merchant trending by mining the social media data.

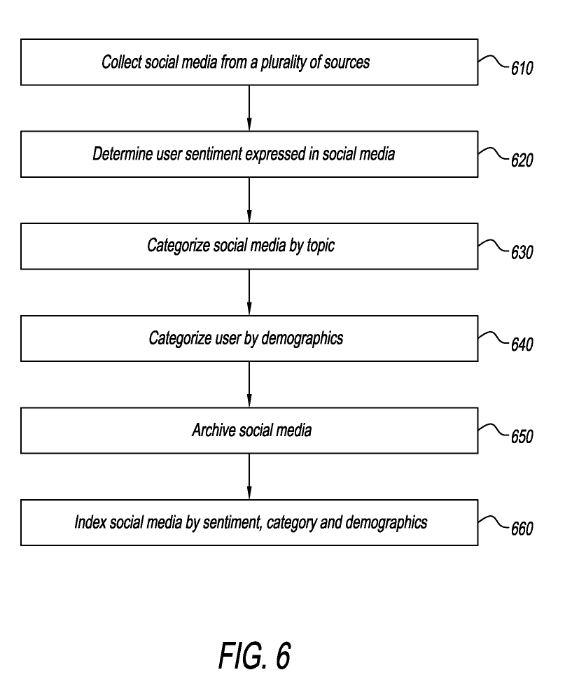

FIG. 6 illustrates a method for aggregating social media. In block 610, a process running on a server collects social media from a plurality of sources. Such sources can include social networking sites, such as FACEBOOK or LINKEDIN, or microblogging sites such as TWITTER. The process can filter the collected social media by keyword or user ID to reduce the volume of such social media. For example, the process can filter tweets based on a specific company such as “XYZ” and/or “ABC,” since a specific company may only be interested in social media posts that relate to that company. In another example, social media can be filtered by topic, for example “network,” “response time” or “DSL”. A data collection module (such as module 502 of FIG. 5) hosted on a social media analysis server performs the processing of collecting social media from a plurality of sources as described with respect to block 610. The processing of block 610 includes parsing the social media to extract entities such as urls, locations, person names, topic tags, user ID, products, and features of products. The processing of block 610 includes estimating the location from which users submitted social media when the location is not expressly given in the social media.

In block 620, a process running on a server analyzes the social media to determine the user's sentiment, mood or purpose in posting the social media (i.e., a consumer's sentiment of a merchant). The process detects user sentiment in social media by recognizing positive words, such as “awesome,” “rock,” “love” and “beat” and negative words such as “hate,” “stupid” and “fail.” The correlation between a sentiment and key word can vary by source. The process collects and archives only social media posts that express an opinion. The process collects and archives posts expressing an opinion only if a fixed number, for example three, of posts express the same opinion. A sentiment analysis module (such as module 505 of FIG. 5) hosted on a social media analysis server performs the processing described with respect to block 620.

In block 630, a process running on a server analyzes the social media to categorize the media by one or more topics. Such topics can include brand (e.g., “Honda” or “Coca Cola”) product type (“car” or “SUV”), or product quality (“good,” “bad” or “unreliable”). Such topics can be predefined, or the process can determine topics dynamically by consolidating social media posts from multiple users. The process can use such topics to cluster social media posts. The process can assign specific topics a priority or importance. For example, the process can assign a topic such as “network outage” a higher priority than “slow response”. A social data categorization module (such as module 510 of FIG. 5) hosted on a social media analysis server performs the processing described with respect to block 630.

In block 640, a process running on a server analyzes the user posting the social media to categorize users associated with each post by one or more demographic categories. Such categories can include age, income level and interests (e.g., classical music or cross country skiing). Such categories can include user location (e.g., city, state or region). The process can determine such information from user profile data or from the content of social media posts. The process can determine such information by mining a user's social network (e.g., the user's friends on FACEBOOK, and the like). A user categorization module (such as module 515 of FIG. 5) hosted on a social media analysis server performs the processing described with respect to block 640. The processing of block 640 additionally includes determining the influence of individual users within their demographic group.

In block 650, a process running on a server archives the social media to a computer readable medium. The process can store the social media on any type of database known in the art, such as, for example, a relational database. The database can include all, or a subset of the data collected in the operation described above with respect to block 610. For example, the process can only archive data relating to specific entities (e.g. “XYZ”) and/or topics (“network” or “customer service”). A data archiving module (such as module 520 of FIG. 5) hosted on a social media analysis server performs the processing described with respect to block 650.

In addition to archiving social media with high precision and recall, the system archives user profiles and the social connections of the users associated with the social media along with the social media. The processing of block 640 collects all such information. Additionally or alternatively, the processing of block 650 includes retrieving the user profiles and social connections of users relating to the archived social media.

In block 660, a process running on a server indexes the archived social media by one or more properties. The process indexes the data to allow for efficient retrieval of social media by its properties. Such properties can include, for example, key words, user sentiments, category, or user demographics. A data indexing module (such as module 530 of FIG. 5) hosted on a social media analysis server performs the processing described with respect to block 660.

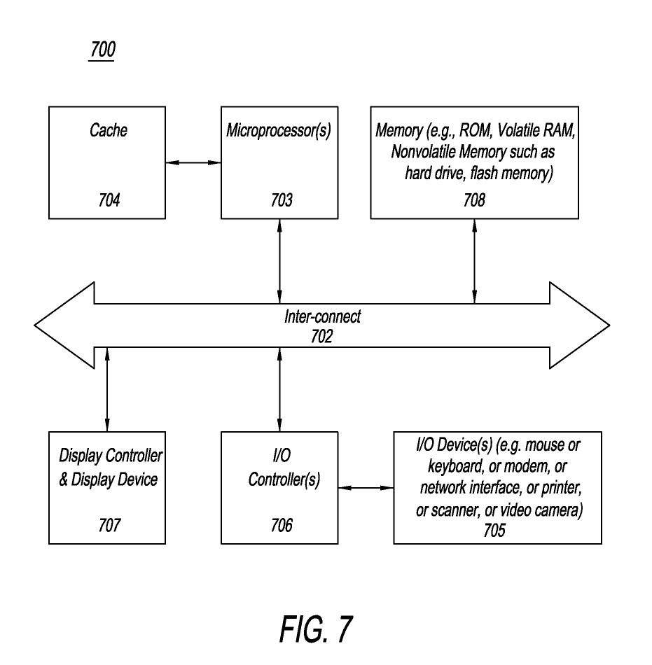

FIG. 7 shows a block diagram of a data processing system 700 that can be used in various embodiments of social media data mining. While FIG. 7 illustrates various components of a computer system, it is not intended to represent any particular architecture or manner of interconnecting the components. Other systems that have fewer or more components can also be used. One or more data processing systems, such as that shown in 700 of FIG. 7, implement the social media analysis servers 500 shown in FIGS. 4 and 5. A data processing system, such as that shown in 700 of FIG. 7, implements each of the modules 502-540 of the social media analysis server 500 of FIG. 5, where each of the modules comprises computer-executable instructions stored on the system's memory 708, such instructions being executed by the system's microprocessor 703. Other configurations are possible, as will be readily apparent to those skilled in the art.

In FIG. 7, the data processing system 700 includes an inter-connect 702 (e.g., bus and system core logic), which interconnects a microprocessor(s) 703 and memory 708. The microprocessor 703 is coupled to cache memory 704 in the example of FIG. 7.

The inter-connect 702 interconnects the microprocessor(s) 703 and the memory 708 together and also interconnects them to a display controller and display device 707 and to peripheral devices, such as input/output (I/O) devices 705, through an input/output controller(s) 706. Typical I/O devices include mice, keyboards, modems, network interfaces, printers, scanners, video cameras and other devices which are well known in the art.

The inter-connect 702 can include one or more buses connected to one another through various bridges, controllers and/or adapters. The I/O controller 706 includes a USB (Universal Serial Bus) adapter for controlling USB peripherals, and/or an IEEE-1394 bus adapter for controlling IEEE-1394 peripherals.

The memory 708 can include ROM (Read Only Memory), and volatile RAM (Random Access Memory) and non-volatile memory, such as hard drive, flash memory, and the like.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system that maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The social media analysis servers 500 are implemented using one or more data processing systems as illustrated in FIG. 7. In some embodiments, one or more servers of the system illustrated in FIG. 7 are replaced with the service of a peer to peer network or a cloud configuration of a plurality of data processing systems, or a network of distributed computing systems. The peer to peer network, or cloud based server system, can be collectively viewed as a server data processing system.

Embodiments of this disclosure can be implemented via the microprocessor(s) 703 and/or the memory 708. For example, the functionalities described above can be partially implemented via hardware logic in the microprocessor(s) 703 and partially using the instructions stored in the memory 708. Some embodiments are implemented using the microprocessor(s) 703 without additional instructions stored in the memory 708. Some embodiments are implemented using the instructions stored in the memory 708 for execution by one or more general purpose microprocessor(s) 703. Thus, this disclosure is not limited to a specific configuration of hardware and/or software.

In an embodiment, consumer sentiment at an aggregate or micro level is quantified so that it can be analyzed with the merchant aggregated payment card transaction data to identify one or more correlations between the merchant aggregated payment card transaction data and the social media information indicative of consumer sentiment of the merchant. Although survey data can be used to quantify consumer sentiment at an aggregate or micro level, survey data may be biased by a number of factors relevant to surveys in general. For example, survey questions are interpreted differently by different people, which can produce misleading and varying results. For example, the types of people who respond to surveys are a biased sample of the general population. For example, surveys performed over a period of time and/or a geographic region average out information across time and space, smoothing out data granularity needed for a better model of consumer behavior.

In accordance with this disclosure, social media data that records consumer communications is used to quantify consumer sentiment of a merchant. The spontaneous nature of the social media data provides better insights into true consumer sentiment of a merchant.

Social media data and other data that reflects consumer sentiment of a merchant are used to quantify the consumer sentiment at both an aggregate and micro level. Using the social media data, the system can reveal micro-granularity in consumer sentiment that is typically smoothed out in quantification results obtained via a survey approach (e.g., based on aggregating responses from questionnaires and polls).

Consumer sentiment of a merchant is established via evaluating consumer sentiment information derived from one or more different social media data sources, such as social network feeds, news feeds, and the like. Such social media data sources are analyzed to quantify consumer sentiment, and together with merchant aggregated payment card transaction data for a defined time period, are used to identify one or more correlations between the merchant aggregated payment card transaction data and the social media information indicative of consumer sentiment of the merchant, and assess the financial condition of the merchant based on the one or more correlations. The consumer sentiment of the merchant can be designated as positive, negative or neutral.

A computing system is configured to digest certain social media data sources and extract consumer sentiment of the merchant content from these data sources. After adjusting for regional and temporal differences, the consumer sentiment of the merchant content is matched with merchant aggregated payment card transaction data to build correlations for assessing the financial condition of the merchant for a defined time period. The correlations can be used to assess the future financial condition of the merchant, providing near real time measurement of consumer sentiment of the merchant and current merchant aggregated payment card transaction data at various summary levels.

Illustrative correlations between the merchant aggregated payment card transaction data and the social media information indicative of consumer sentiment of the merchant include, for example, positive correlations between merchant positive sentiment and positive number of merchant aggregated payment card transactions, or positive GDV of merchant aggregated payment card transactions for a defined time period, and negative correlations between merchant negative sentiment and negative number of merchant aggregated payment card transactions, or negative GDV of merchant aggregated payment card transactions for a defined time period. Mixed positive and negative correlations are also part of this disclosure. The correlations can be designated as positive, negative or neutral.

For example, the social media (i.e., TWITTER) is mined to determine customer sentiment for a merchant for a particular period of time. The mining shows 5100 tweets having positive sentiment and 1200 tweets having negative sentiment for the merchant for a first month period. Analysis of the merchant aggregated payment card transactions for the first month period shows the number of merchant aggregated payment card transactions is 110,000 and the GDV is $850,000. Subsequent mining shows 5200 tweets having positive sentiment and 1100 tweets having negative sentiment for the merchant for a second month period. Analysis of the merchant aggregated payment card transactions for the second month period shows the number of merchant aggregated payment card transactions is 115,000 and the GDV is $875,000. The data shows a positive trending correlation between merchant positive sentiment and positive number of merchant aggregated payment card transactions, and positive GDV of merchant aggregated payment card transactions, for a defined time period. The financial condition of the merchant is then assessed, at least in part, based on the positive trending correlations.

For another example, the social media (i.e., TWITTER) is mined to determine customer sentiment for the merchant for a particular period of time. The mining shows 28300 tweets having positive sentiment and 13300 tweets having negative sentiment for the merchant for a first month period. Analysis of the merchant aggregated payment card transactions for the first month period shows the number of merchant aggregated payment card transactions is 140,000 and the GDV is $950,000. Subsequent mining shows 27300 tweets having positive sentiment and 14300 tweets having negative sentiment for the merchant for a second month period. Analysis of the merchant aggregated payment card transactions for the second month period shows the number of merchant aggregated payment card transactions is 120,000 and the GDV is $850,000. The data shows a negative trending correlation between merchant positive sentiment and positive number of merchant aggregated payment card transactions, and positive GDV of merchant aggregated payment card transactions, for a defined time period. The financial condition of the merchant is then assessed, at least in part, based on the negative trending correlations.

The correlations can be updated or refreshed at a specified time (e.g., on a regular basis or upon request of a party). Updating the correlations can include updating the social media data, and optionally demographic data and/or updated geographic data. The correlations can also be updated by generating new merchant aggregated payment card transaction data. The process for updating correlations can depend on the circumstances regarding the need for the information itself.

One or more algorithms can be employed to determine formulaic descriptions of the assembly of the merchant aggregated payment card transaction data information, social media information, and optionally demographic and/or geographic information, using any of a variety of known mathematical techniques. These formulas in turn can be used to derive or generate indexing using any of a variety of available analysis algorithms.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A computer implemented method comprising:
retrieving a first set of information from one or more databases, the first set of information including merchant aggregated payment card transaction data for a defined time period;
retrieving a second set of information from the one or more databases, the second set of information comprising social media information indicative of consumer sentiment of the merchant for the defined time period;
analyzing the first set of information and the second set of information at a processor to identify one or more correlations between the merchant aggregated payment card transaction data and the social media information indicative of consumer sentiment of the merchant; and
assessing the financial condition of a merchant based on the one or more correlations.

2. The method of claim 1, further comprising algorithmically analyzing the first set of information and the second set of information to identify the one or more correlations between the merchant aggregated payment card transaction data and the social media information indicative of consumer sentiment of the merchant, for the defined time period.

3. The method of claim 1, wherein the first set of information includes one or more of the following: payment card transaction data and merchant data, and optionally geographic and/or demographic information.

4. The method of claim 1, wherein the second set of information is retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines.

5. The method of claim 1, wherein the second set of information is generated by:
collecting, using a computing device, a plurality of social media posts relating to at least one merchant; and
analyzing, using the computing device, a consumer sentiment of the at least one merchant expressed in each of the plurality of social media posts.

6. The method of claim 5, further comprising:
categorizing, using the computing device, each of the plurality of social media posts into the at least one topic;
categorizing, using the computing device, users associated with each of the plurality of social media posts into at least one demographic category;
archiving, using the computing device, each of the plurality of social media posts to a database stored on a computer readable medium;
indexing, using the computing device, each of the plurality of social media posts stored on the computer readable medium by the respective sentiment, the at least one topic and the at least one demographic category of each of the social media posts.

7. The method of claim 5, wherein the plurality of social media posts are collected from a plurality of social media websites.

8. The method of claim 5, wherein collecting social media posts additionally comprises collecting user profiles and social connections of the users associated with the social media posts, and wherein the profiles and social connections are archived to the database in association with each of the social media posts to which they relate.

9. The method of claim 1, wherein consumer sentiment of the merchant is selected from positive, negative and neutral.

10. The method of claim 1, wherein the merchant aggregated payment card transaction data is the number of merchant aggregated payment card transactions, or the gross dollar volume (GDV) of merchant aggregated payment card transactions, for a defined time period.

11. The method of claim 1, wherein the method is carried out by a financial transaction processing entity.

12. A system comprising:
one or more databases comprising a first set of information, the first set of information including merchant aggregated payment card transaction data for a defined time period;
one or more databases comprising a second set of information, the second set of information including social media information indicative of consumer sentiment of the merchant for the defined time period;
a processor configured to:
analyze the first set of information and the second set of information to identify one or more correlations between the merchant aggregated payment card transaction data and the social media information indicative of consumer sentiment of the merchant; and
assess the financial condition of a merchant, based on the one or more correlations.

13. The system of claim 12, further comprising algorithmically analyzing the first set of information and the second set of information to identify the one or more correlations between the merchant aggregated payment card transaction data and the social media information indicative of consumer sentiment of the merchant, for the defined time period.

14. The system of claim 12, wherein the first set of information includes one or more of the following: payment card transaction data and merchant data, and optionally geographic and/or demographic information.

15. The system of claim 12, wherein the second set of information is retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines.

16. The system of claim 12, wherein the second set of information is generated by:
collecting, using a computing device, a plurality of social media posts relating to at least one merchant; and
analyzing, using the computing device, a consumer sentiment of the at least one merchant expressed in each of the plurality of social media posts.

17. The system of claim 16, further comprising:
categorizing, using the computing device, each of the plurality of social media posts into the at least one topic;
categorizing, using the computing device, users associated with each of the plurality of social media posts into at least one demographic category;
archiving, using the computing device, each of the plurality of social media posts to a database stored on a computer readable medium; and
indexing, using the computing device, each of the plurality of social media posts stored on the computer readable medium by the respective sentiment, the at least one topic and the at least one demographic category of each of the social media posts.

18. The system of claim 16, wherein collecting social media posts additionally comprises collecting user profiles and social connections of the users associated with the social media posts, and wherein the profiles and social connections are archived to the database in association with each of the social media posts to which they relate.

19. The system of claim 12, wherein the merchant aggregated payment card transaction data is the number of merchant aggregated payment card transactions, or the gross dollar volume (GDV) of merchant aggregated payment card transactions, for a defined time period.

20. The system of claim 12, wherein the method is carried out by a financial transaction processing entity.
